(19) United States
(12) Patent Application Publication
(10) Pub. No.: US 2014/0173223 A1
(43) Pub. Date: Jun. 19, 2014

(54) STORAGE CONTROLLER WITH HOST COLLABORATION FOR INITIALIZATION OF A LOGICAL VOLUME

(71) Applicants: Nathaniel S DeNeui, Houston, TX (US); Joseph David Black, Houston, TX (US); Nhan Q Vo, Cypress, TX (US)

(72) Inventors: Nathaniel S DeNeui, Houston, TX (US); Joseph David Black, Houston, TX (US); Nhan Q Vo, Cypress, TX (US)

(21) Appl. No.: 14/235,793

(22) PCT Filed: Dec. 13, 2011
(86) PCT No.: PCT/US2011/064625

§ 371 Date: Jan. 28, 2014

(51) Int. Cl. G06F 3/06

(52) U.S. Cl. CPC G06F 3/0631; G06F 3/0604; G06F 3/0673
USPC 711/154

(57) ABSTRACT

A device includes a storage controller for accessing a logical volume. The storage controller collaborates with a host to initialize the logical volume such that host resources perform a portion of the initialization of the logical volume.

### BACKGROUND

Storage controllers, such as Redundant Array of Independent Disks (RAID) controllers, are used to organize physical memory devices, such as hard disks or other storage devices, into logical volumes that can be accessed by a host. For optimal performance, a logical volume may be initialized by the storage controller. The initialization may be a parity initialization process, a rebuild process, a RAID level/stripe size migration process, a volume expansion process, or an erase process for the logical volume.

The memory resources of the storage controller limit the rate at which a storage controller can perform an initialization process on a logical volume. Further, concurrent host input/output (I/O) operations during an initialization process do not contribute to the initialization process and may consume storage controller resources that prevent the storage controller from making progress toward completion of the initialization process. In addition, as hardware improves, physical disk capacities are increasing in size, thereby increasing the number of individual I/O operations needed to complete an initialization process on a logical volume.

With increasing requirements for performance and redundancy, initialization processes are becoming increasingly longer, which may result in suboptimal performance by the storage controller. A longer initialization time results in a longer amount of time in either a low-performance state (e.g., for an incomplete parity initialization process) or in a degraded state with loss of data redundancy for large sections of the logical volume (e.g., for an incomplete rebuild process).

### BRIEF DESCRIPTION OF THE DRAWINGS

FIG. 1 is a block diagram illustrating one example of a system.

FIG. 2 is a block diagram illustrating one example of a server.

FIG. 3 is a block diagram illustrating one example of a storage controller.

FIG. 4 is a functional block diagram illustrating one example of the initialization of logical volumes.

FIG. 5 is a block diagram illustrating one example of a sparse sequence metadata structure.

FIG. 6 is a functional block diagram illustrating one example of updating/tracking metadata via the sparse sequence metadata structure.

FIG. 7 is a flow diagram illustrating one example of a method for initializing a logical volume.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims, it is to be understood that features of the various examples described herein may be combined with each other, unless specifically noted otherwise.

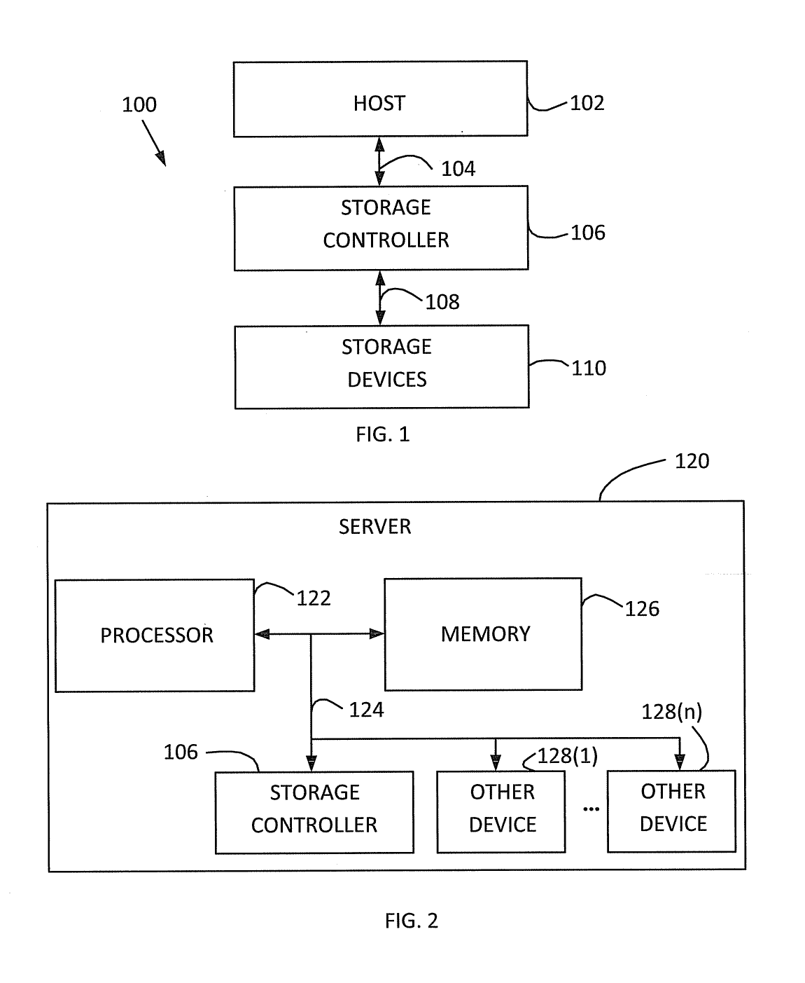

FIG. 1 is a block diagram illustrating one example of a system 100. System 100 includes a host 102, a storage controller 106, and storage devices 110. Host 102 is communicatively coupled to storage controller 106 via communication link 104. Storage controller 106 is communicatively coupled to storage devices 110 via communication link 108. Host 102 is a computing device, such as a server, a personal computer, or other suitable computing device that reads data from and stores data in storage devices 110 using logical block addressing. Storage controller 106 provides an interface between host 102 and storage devices 110 for translating the logical block addresses used by host 102 to physical block addresses for accessing storage devices 110.

Storage controller 106 also performs initialization processes on logical volumes mapped to physical volumes of storage devices 110 including parity initialization processes, rebuild processes, Redundant Array of Independent Disks (RAID) level/strip size migration processes, volume expansion processes, erase processes, and/or other suitable initialization processes. During an initialization process, storage controller 106 tracks the progress of the initialization process by tracking write operations performed by both storage controller 106 and host 102 to the logical volume or volumes being initialized. In one example, by tracking user initiated write operations (i.e., write operations generated by normal use of the storage controller outside of an initialization process) performed by host 102 to a logical volume being initialized, host 102 indirectly contributes toward the completion of the initialization process since storage controller 106 does not have to repeat the write operations performed by host 102. In another example, host 102 also actively contributes to the completion of the initialization process by directly performing at least a portion of the write operations for the initialization process in collaboration with storage controller 106.

The collaboration of host 102 and storage controller 106 for completing initialization processes on logical volumes speeds up the initialization processes compared to conventional storage controllers that cannot collaborate with the host. Therefore, the logical volumes are returned to a high performance operating state more quickly than in a conventional system. In addition, in one example, unutilized host resources can be allocated to perform initialization processes, thereby more efficiently using the available resources. In one example, a user can directly specify the rate of the initialization processes by enabling host Input/Output (I/O) to manage host resources for performing the initialization processes.

FIG. 2 is a block diagram illustrating one example of a server 120. Server 120 includes a processor 122, a memory 126, a storage controller 106, and other devices 128(1)-128(n), where “n” is an integer representing any suitable number of other devices. In one example, processor 122, memory 126, and other devices 128(1)-128(n) provide host 102 previously described and illustrated with reference to FIG. 1. Processor 122, memory 126, storage controller 106, and other devices 128(1)-128(n) are communicatively coupled to each other via a communication link 124. In one example, communication link 124 is a bus. In one example, communication link 124 is a high speed bus, such as a Peripheral Component Interconnect Express (PCIe) bus or other suitable high speed bus. Other devices 128(1)-128(n) include network interfaces, other storage controllers, display adaptors, I/O devices, and/or other suitable devices that provide a portion of server 120.

Processor 122 includes a Central Processing Unit (CPU) or other suitable processor. In one example, memory 126 stores instructions executed by processor 122 for operating server 120. Memory 126 includes any suitable combination of volatile and/or non-volatile memory, such as combinations of Random Access Memory (RAM), Read-Only Memory (ROM), flash memory, and/or other suitable memory. Processor 122 accesses storage devices 110 (FIG. 1) via storage controller 106. Processor 122 resources are used to collaborate with storage controller 106 for performing initialization processes on logical volumes as previously described with reference to FIG. 1.

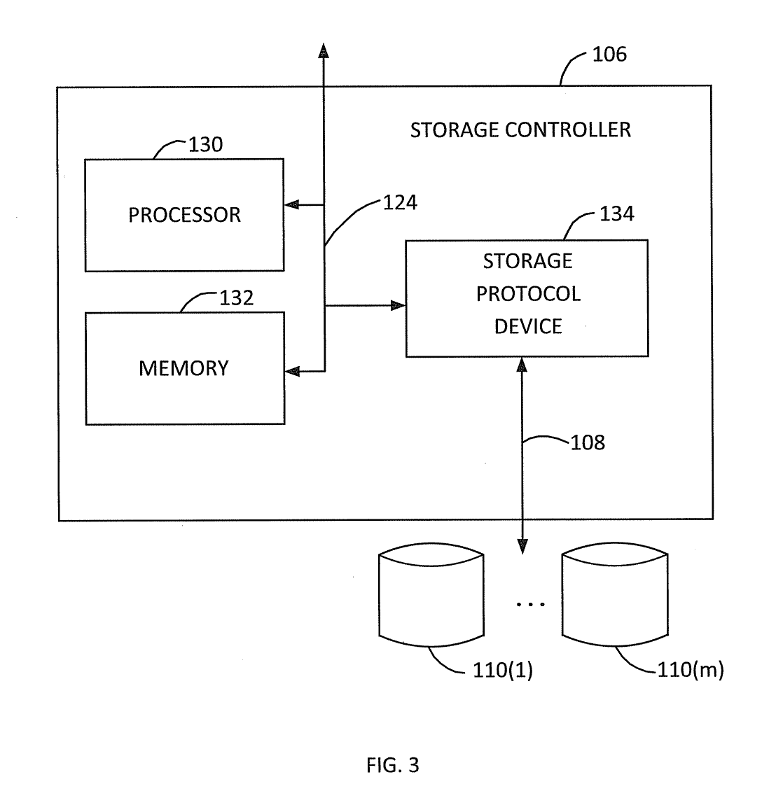

FIG. 3 is a block diagram illustrating one example of a storage controller 106. Storage controller 106 includes a processor 130, a memory 132, and a storage protocol device 134. Processor 130, memory 132, and storage protocol device 134 are communicatively coupled to each other via communication link 124. Storage protocol device 134 is communicatively coupled to storage devices 110(a)-110(m) via communication link 108, where “m” is an integer representing any suitable number of storage devices. Storage devices 110(1)-110(m) include hard disk drives, flash drives, optical drives, and/or other suitable storage devices. In one example, communication link 108 includes a bus, such as a Serial Advanced Technology Attachment (SATA) bus or other suitable bus.

Processor 130 includes a Central Processing Unit (CPU), a controller, or another suitable processor. In one example, memory 132 stores instructions executed by processor 130 for operating storage controller 106. Memory 132 includes any suitable combination of volatile and/or non-volatile memory, such as combinations of RAM, ROM, flash memory, and/or other suitable memory. Storage protocol device 134 converts commands to storage controller 106 received from a host into commands for assessing storage devices 110(1)-110(m). Processor 130 executes instructions for converting logical block addresses received from a host to physical block addresses for accessing storage devices 110(1)-110(m). In addition, processor 130 executes instructions for performing initialization processes on logical volumes mapped to physical volumes of storage devices 110(a)-110(m) and for tracking the progress of the initialization processes as previously described with reference to FIG. 1.

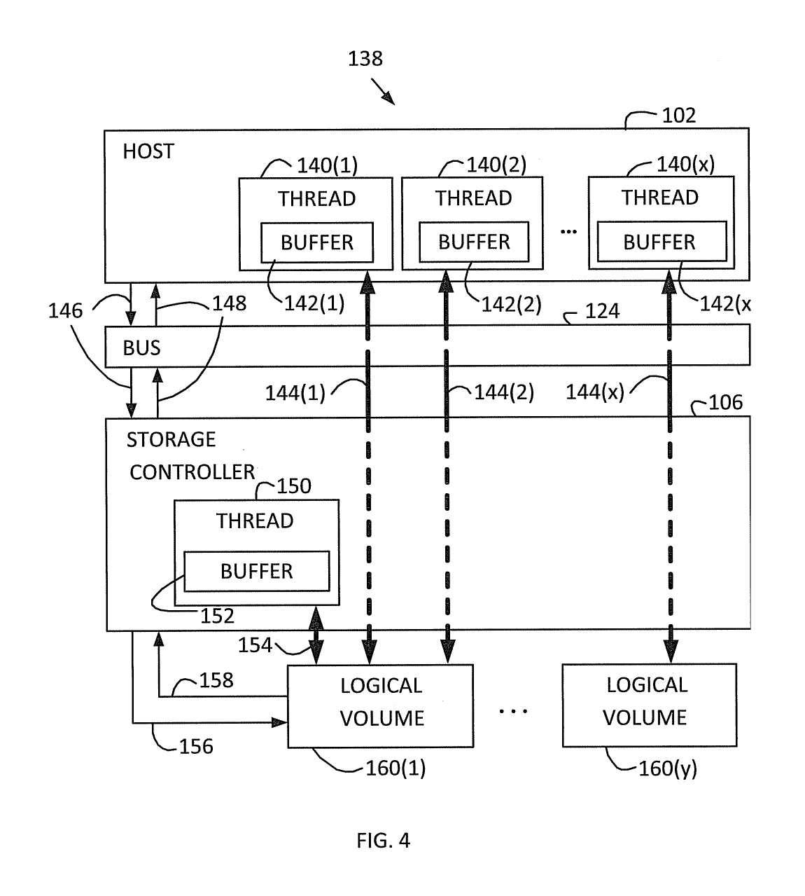

FIG. 4 is a functional block diagram 138 illustrating one example of the initialization of logical volumes 160(1)-160(y), where “y” is an integer representing any suitable number of logical volumes. Logical volumes 160(1)-160(y) are mapped to physical volumes of storage devices 110(1)-110(m) (FIG. 3). Host 102 sends control commands to storage controller 106 via communication link 124 as indicated at 146. Storage controller 106 sends control commands to host 102 via communication link 124 as indicated at 148. Storage controller 106 sends control commands to logical volumes 160(1)-160(y) as indicated at 156. Logical volumes 160(1)-160(y) send control commands to storage controller 106 as indicated at 158.

In this example, host 102 actively contributes to the completion of initialization of logical volumes 160(a)-160(y) by allocating host resources to the initialization processes. Upon notification of an initialization process for a logical volume 160(1)-160(y), host 102 allocates a compute thread or threads 140(1)-140(x) for the initialization process, where “x” is an integer representing any suitable number of allocated compute threads. In one example, the number of compute threads allocated to the initialization processes is user specified. Host 102 may be notified of initialization processes by storage controller 106, by polling storage controller 106 for the information, or by another suitable technique. Each compute thread 140(1)-140(x) is allocated its own buffer 142(1)-142(x), respectively, for initiating read and write operations to logical volumes 160(1)-160(y).

In this example, compute thread 140(1) and buffer 142(1) initiate read and write operations to logical volume 160(1) as indicated at 144(1) to contribute toward the completion of an initialization process of logical volume 160(1). Compute thread 140(2) and buffer 142(2) also initiate read and write operations to logical volume 160(1) as indicated at 144(2) to contribute toward the completion of the initialization process of logical volume 160(1). Compute thread 140(x) and buffer 142(x) initiate read and write operations to logical volume 160(y) as indicated at 144(x) to contribute toward the completion of the initialization process of logical volume 160(y). In other examples, other compute treads and respective buffers are allocated to initiate read and write operations to other logical volumes to contribute toward the completion of the initialization processes of the logical volumes. The read and write operations from host 102 to logical volumes 160(1)-160(y) as indicated at 144(1)-144(x) pass through bus 124 and storage controller 106. in one example, host 102 blocks user initiated write operations to a block of a logical volume that is currently being operated on by a compute thread 140(1)-140(x).

Storage controller 106 includes a compute tread 150 and a buffer 152 to initiate read and write operations to logical volume 160(1) as indicated at 154 to contribute toward the completion of the initialization process of logical volume 160(1). In other examples, compute tread 150 and buffer 152 initiate read and write operations to another logical volume to contribute toward the completion of the initialization process of the logical volume. Thus, in this example, compute thread 140(1) with buffer 142(1) of host 102, compute tread 140(2) with buffer 142(2) of host 102, and compute thread 150 with buffer 152 of storage controller 106 initiate read and write operations in parallel to logical volume 160(1) to complete an initialization process of logical volume 160(1).

Storage controller 106 also tracks the progress of the initialization processes of logical volumes 160(1)-160(y). For each individual logical volume 160(1)-160(y), storage controller 106 tracks which logical blocks have been initialized. For example, for logical volume 160(1), storage controller 106 tracks which logical blocks have been initialized by write operations initiated by compute thread 150 with buffer 152 of storage controller 106, write operations initiated by compute thread 140(1) with buffer 142(1) of host 102, and write operations initiated by compute thread 140(2) with buffer 142(2) of host 102. Likewise, for logical volume 160(y), storage controller 106 tracks which logical blocks have been initialized by write operations initiated by compute tread 140(x) with buffer 142(x). In one example, storage controller 106 periodically sends the tracking information to host 102 so that host 102 does not repeat initialization operations performed by storage controller 106. In another example, host 102 polls storage controller 106 for changes in the tracking information so that host 102 does not repeat initialization operations performed by storage controller 106.

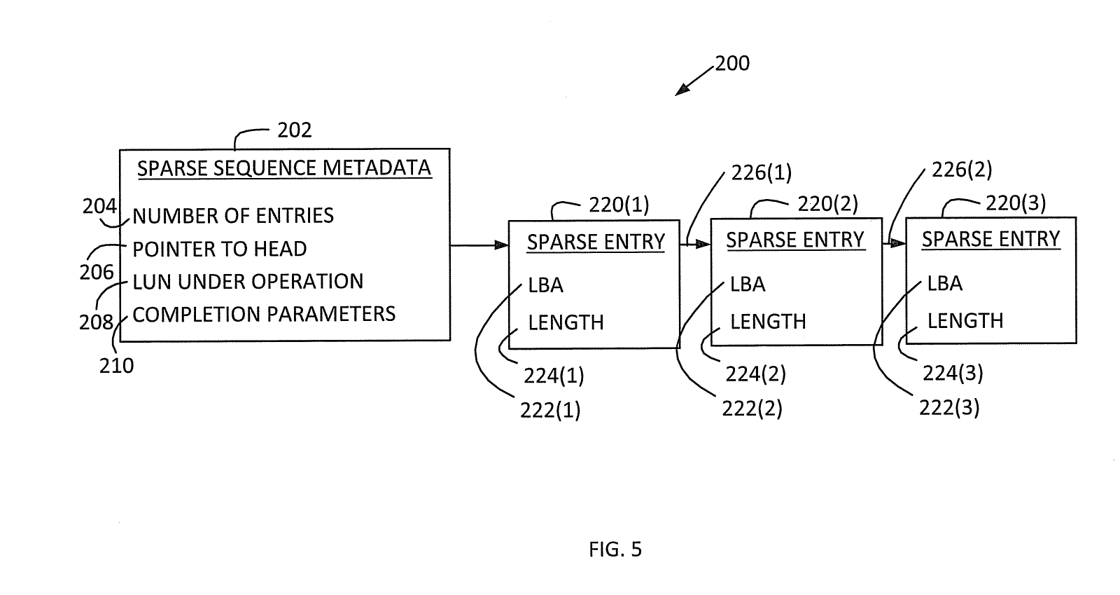

FIG. 5 is a block diagram illustrating one example of a sparse sequence metadata structure 200. In one example, sparse sequence metadata structure 200 is used by storage controller 106 (FIGS. 1-4) for tracking the progress of the initialization process of a logical volume, such as a logical volume 160(1)-160(y) (FIG. 4). Storage controller 106 creates a sparse sequence metadata structure 200 for each logical volume when an initialization process of a logical volume is started. Once the initialization process of the logical volume is complete based on metadata stored in the sparse sequence metadata structure 200, the sparse sequence metadata structure 200 is erased.

In this example, sparse sequence metadata structure 200 includes sparse sequence metadata 202 and sparse entries 220(1), 220(2), and 220(3). The number of sparse entries of sparse sequence metadata structure 200 may vary during the initialization process of a logical volume. When the initialization of a logical volume is complete, the sparse sequence metadata structure 200 for the logical volume will include only one sparse entry.

Sparse sequence metadata 202 includes a number of fields including the number of sparse entries as indicated at 204, a pointer to the head of the sparse entries as indicated at 206, the logical volume or Logical Unit Number (LUN) under operation as indicated at 208, and completion parameters as indicated at 210. In one example, the completion parameters include the range of logical block addresses for satisfying the initialization process of the logical volume. In other examples, sparse sequence metadata 202 may include other suitable fields for sparse sequence metadata structure 200.

Each sparse entry 220(1), 220(2), and 220(3) includes two fields including a Logical Block Address (LBA) as indicated at 222(1), 222(2), and 222(3) and a length as indicated at 224(1), 224(2), and 224(3), respectively. The logical block address and the length of each sparse entry indicate a portion of the logical volume that has been initialized. Sparse sequence metadata 202 is linked to the first sparse entry 220(1) as indicated at 212 via the pointer to the head 206. First sparse entry 220(1) is linked to the second sparse entry 220(2) as indicated at 226(1). Likewise, second sparse entry 220(2) is linked to the third sparse entry 220(3) as indicated at 226(2). Similarly, third sparse entry 220(3) may be linked to additional sparse entries (not shown). In one example, sparse entries 220(1), 220(2), and 220(3) are arranged in order based on the logical block addresses 222(1), 222(2), and 222(3), respectively.

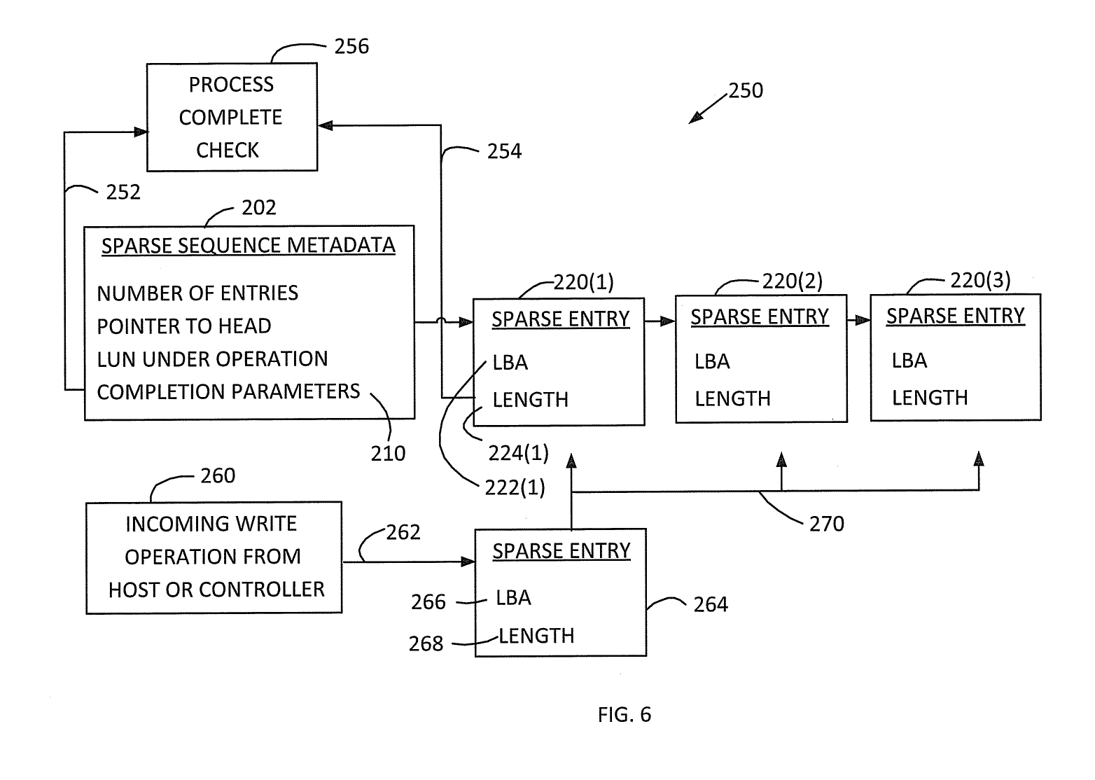

FIG. 6 is a functional block diagram 250 illustrating one example of updating/tracking metadata via the sparse sequence metadata structure 200 previously described and illustrated with reference to FIG. 5. For each incoming write operation from host 102 or storage controller 106 to the logical volume under operation as indicated at 260, storage controller 106 generates a sparse entry 264 as indicated at 262. Sparse entry 264 includes the LBA as indicated at 266 and the length as indicated at 268 of the portion of the logical volume that is being initialized by the write operation. After generating sparse entry 264, storage controller 106 either merges sparse entry 264 into an existing sparse entry (e.g., sparse entry 220(1), 220(2), or 220(3)) or inserts sparse entry 264 into sparse sequence metadata structure 200 at the proper location as indicated at 270.

For example, if sparse entry 264 includes an LBA 266 and a length 268 indicating a portion of the logical volume that is contiguous to (i.e., either directly before or directly after) a portion of the logical volume indicated by the LBA and length of an existing sparse entry, storage controller 106 modifies the existing sparse entry. The existing sparse entry is modified to include the proper LBA and length such that the modified sparse entry indicates both the previously initialized portion of the logical volume based on the existing sparse entry and the newly initialized portion of the logical volume based on sparse entry 264. If sparse entry 264 includes an LBA 266 and a length 268 indicating a portion of the logical volume that is not contiguous to a portion of the logical volume indicated by the LBA and length of an existing sparse entry, storage controller 106 inserts sparse entry 264 at the proper location in sparse sequence metadata structure 200. Storage controller 106 inserts sparse entry 264 prior to the first sparse entry (e.g., sparse entry 220(1)), between sparse entries (e.g., between sparse entry 220(1) and sparse entry 220(2) or between sparse entry 220(2) and sparse entry 220(3)), or after the last sparse entry (e.g., sparse entry 220(3)) based on the LBA 266.

After each write operation, storage controller 106 performs a process complete check as indicated at 256. The process complete check receives the completion parameters 210 as indicated at 252 and the LBA 222(1) and length 224(1) from the first sparse entry 220(1) as indicated at 254. The process complete check compares the completion parameters 210 from sparse sequence metadata 202 to the LBA 222(1) and length 224(1) from the first sparse entry 220(1), Upon completion of the initialization of a logical volume, sparse sequence metadata structure 200 will include only the first sparse entry 220(1), which will include an LBA 222(1) and a length 224(1) indicating the LBA range for satisfying the initialization process. Thus, by comparing the LBA 222(1) and length 224(1) of sparse entry 220(1) to the completion parameters 210, storage controller 106 determines whether the initialization process of the logical volume is complete. In one example, upon completion of the initialization process of a logical volume, storage controller 106 erases the sparse sequence metadata structure for the logical volume.

By tracking the portions of the logical volume that have been initialized via a sparse sequence metadata structure, compute threads of host 102 may operate in any area of the logical volume, even disjunct areas, without taxing storage controller 106 resources. In one example, storage controller 106 may be utilized to fill in the disjunct areas between host 102 compute thread operations. In addition, by using a sparse sequence metadata structure, storage controller 106 does not have to store large amounts of metadata to track the progress of multiple disjunct sections of the logical volume. User initiated write operations from the host generated by the normal use of the storage controller outside of an initialization process are also counted towards the initialization process and tracked by the sparse sequence metadata structure.

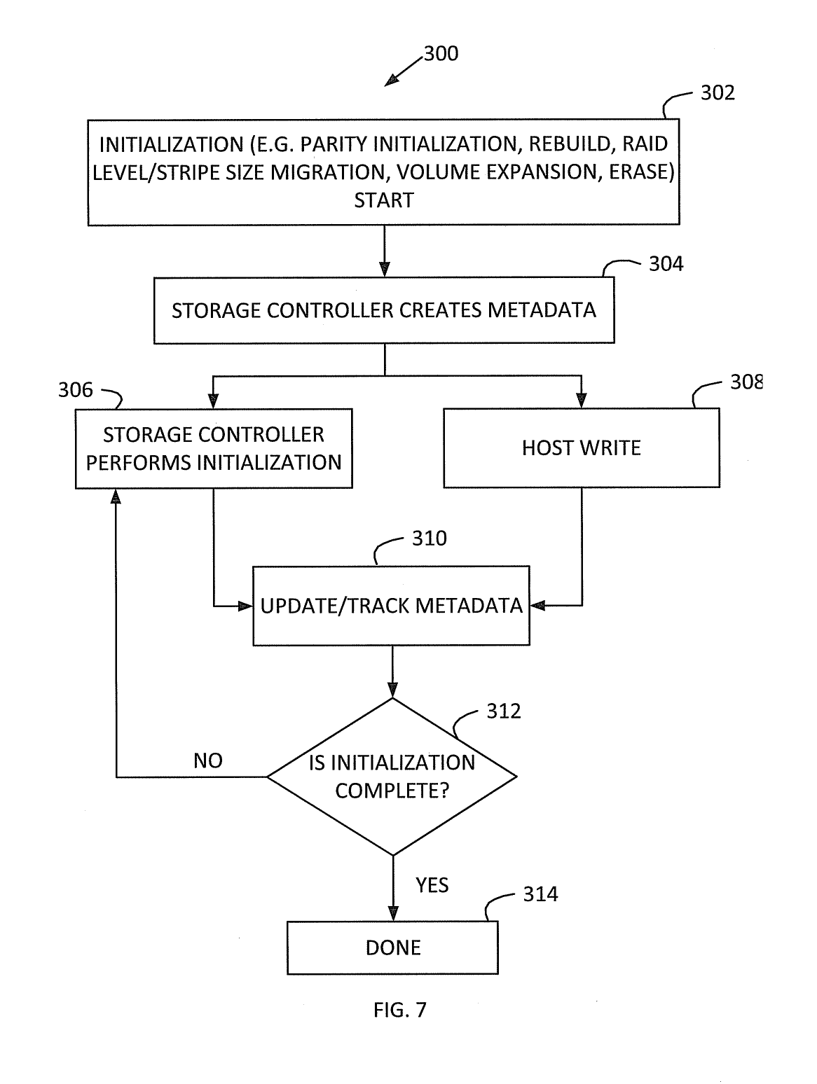

FIG. 7 is a flow diagram illustrating one example of a method 300 for initializing a logical volume (e.g., logical volume 160(1) or logical volume 160(y) previously described and illustrated with reference to FIG. 4). At 302, an initialization process of a logical volume is started. The initialization process may include a parity initialization process, a rebuild process, a RAID level/stripe size migration process, a volume expansion process, an erase process, or another suitable initialization process. The initialization of the logical volume may be started by the storage controller or the host.

At 304, the storage controller (e.g., storage controller 106 previously described and illustrated with reference to FIGS. 1-4) creates metadata to track the progress of the initialization process (e.g., sparse sequence metadata structure 200 previously described and illustrated with reference to FIG. 5). At 306, the storage controller performs an initialization operation on the logical volume. At 308, in parallel with the storage controller initialization operation, the host performs a write operation on the logical volume. In one example, the host write operation is a user initiated write operation generated by the normal use of the storage controller outside of the initialization process. In another example, the host write operation is an initialization operation for actively contributing to the initialization process.

At 310, the storage controller updates/tracks the metadata for the storage controller initialization operation and/or for the host write operation. In one example, the storage controller updates/tracks the metadata by updating the sparse sequence metadata structure for the logical volume. At 312, the storage controller determines whether the initialization process is complete based on the metadata. If the initialization process is not complete, then the storage controller performs another initialization operation at 306. The host may also continue to write to the logical volume as indicated at 308. If the initialization process is complete, then the method is done as indicated at 314.

Examples of the disclosure provide a system including a host and a storage controller that collaborate to complete initialization processes on logical volumes. The storage controller tracks the progress of the initialization processes so that operations are not repeated. In one example, the host indirectly contributes to initialization processes through normal host write operations outside of the initialization processes. In another example, the host actively contributes to initialization processes by allocating resources to the initialization processes.

By collaborating to complete initialization processes, unutilized host resources can be allocated to perform initialization operations. A user may configure the rate at which host resources are dedicated to initialization processes, allowing user control of host resources to speed up the initialization processes. The host resources can be used to simultaneously initialize multiple logical volumes on multiple attached storage controllers, allowing for faster parallel initialization processes. Therefore, without increasing the available resources in either the host or the storage controller, the speed of initialization processes is increased over conventional systems in which the host does not collaborate with the storage controller for initialization processes.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A device, comprising:
a storage controller for accessing a logical volume, the storage controller to collaborate with a host to initialize the logical volume such that host resources perform a portion of the initialization of the logical volume.

2. The device of claim 1, wherein the storage controller tracks the progress of the initialization by tracking host write operations and storage controller write operations to the logical volume.

3. The device of claim 2, wherein the storage controller tracks the progress of the initialization via a sparse sequence metadata structure, and
wherein the storage controller generates a sparse entry for each host write operation and for each storage controller write operation and one of merges the generated sparse entry into a previous sparse entry of the sparse sequence metadata structure or inserts the generated sparse entry into the sparse sequence metadata structure.

4. The device of claim 3, wherein the storage controller generates a sparse entry for each user initiated host write operation to the logical volume.

5. The device of claim 1, wherein the host allocates a user specified number of compute threads each with an allocated buffer to perform a portion of the initialization of the logical volume.

6. The device of claim 5, wherein the host blocks user initiated write operations to a block of the logical volume that is currently being operated on by a compute thread.

7. The device of claim 1, wherein the initialization comprises one of a parity initialization process, a rebuild process, a RAID level/stripe size migration process, a volume expansion process, and an erase process.

8. A device, comprising:
a host; and
a storage controller for accessing a logical volume, the storage controller to collaborate with the host to perform an initialization process on the logical volume such that host resources perform a portion of the initialization process,
wherein the storage controller tracks the progress of the initialization process by tracking host write operations and storage controller write operations to the logical volume as contributing to the initialization process.

9. The device of claim 8, wherein the storage controller tracks the progress of the initialization process via a sparse sequence metadata structure for the logical volume, the sparse sequence metadata structure including a sparse entry including a logical block address field and a length field indicating a portion of the logical volume that has been initialized.

10. The device of claim 8, wherein the storage controller and the host perform initialization operations on the logical volume in parallel.

11. A method for initializing a logical volume, the method comprising:
performing initialization operations on the logical volume using storage controller resources;
performing user initiated operations on the logical volume using host resources; and
tracking both the initialization operations performed using storage controller resources and the user initiated operations performed using host resources as contributing to the initialization of the logical volume.

12. The method of claim 11, further comprising:
performing initialization operations on the logical volume using host resources.

13. The method of claim 12, further comprising:
performing initialization operations on a further logical volume using host resources in parallel with the performing of initialization operations on the logical volume.

14. The method of claim 11, wherein the tracking comprises:
generating a sparse entry for a sparse sequence metadata structure for each initialization operation and for each user initiated operation; and
merging the generated sparse entry into a previously generated sparse entry of the sparse sequence metadata structure or inserting the generated sparse entry into the sparse sequence metadata structure.

15. The method of claim 11, wherein performing the initialization operations comprises performing one of parity initialization operations, rebuild operations, RAID level/stripe size migration operations, volume expansion operations, and erase operations.
